(19) United States
(12) Patent Application Publication
(10) Pub. No.: US 2024/0012273 A1
(43) Pub. Date: Jan. 11, 2024

(54) HANDHELD PROTECTIVE EYEWEAR

(71) Applicant: Misla Barco, Redwood City, CA (US)

(72) Inventor: Misla Barco, Redwood City, CA (US)

(21) Appl. No.: 18/297,592

(22) Filed: Apr. 7, 2023

Related U.S. Application Data
(63) Continuation-in-part of application No. 29/845,196, filed on Jul. 5, 2022.

(51) Int. Cl. G02C 11/00

(52) U.S. Cl. CPC G02C 11/00

(57) ABSTRACT

A protective eyewear comprises a lens configured to protect a user's eyes. The protective eyewear further comprises a first holding stick receptacle on a first side of the lens, the first holding stick receptacle comprising a first hole configured to receive the holding stick oriented in a first direction. The protective eyewear further comprises a second holding stick receptacle on a second side of the lens, the second holding stick receptacle comprising a second hole configured to receive the holding stick oriented in the first direction. The protective eyewear further comprises the holding stick, configured to insert into at least one of the first hole of first holding stick receptacle or the second hole of the second holding stick receptacle, wherein the holding stick is configured to be held by the user such that the lens is placed in front of the user's eyes.

### RELATED APPLICATIONS

The present application is a continuation in part application of U.S. Design Pat. No. 29/845,196, filed Jul. 5, 2022.

### TECHNICAL FIELD

The present disclosure is generally related to protective eyewear, and more particularly, to handheld protective eyewear.

### BACKGROUND

Protective eyewear generally comes in two varieties, which include protective eyewear with an elastic band that holds the eyewear in place on a user's head and protective eyewear that includes a temple that holds the eyewear in place on a user's head (e.g., that loops around a user's ear). Both types of protective eyewear are usable for protecting a user's eyes for relatively long durations while leaving the user's hands free for additional tasks. Such protective eyewear is designed to protect a user's eyes during demolition and construction activities such as carpentry, welding, woodworking, masonry, and so on.

### SUMMARY

The following is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In accordance with an embodiment, a protective eyewear comprises: a lens configured to protect a user's eyes when placed in front of the user's eyes; a first holding stick receptacle on a first side of the lens, the first holding stick receptacle comprising a first hole configured to receive the holding stick oriented in a first direction; a second holding stick receptacle on a second side of the lens, the second holding stick receptacle comprising a second hole configured to receive the holding stick oriented in the first direction; and the holding stick, configured to insert into at least one of the first hole of the first holding stick receptacle or the second hole of the second holding stick receptacle, wherein the holding stick is configured to be held by the user such that the lens is placed in front of the user's eyes.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 is a perspective view of a handheld protective eyewear with a holding stick in a first position, in accordance with embodiments of the present disclosure.

FIG. 2 is a front view of the handheld protective eyewear with the holding stick in a first position, in accordance with embodiments of the present disclosure.

FIG. 3 is a rear view of the handheld protective eyewear with the holding stick in a first position, in accordance with embodiments of the present disclosure.

FIG. 4 is a first side view of the handheld protective eyewear with the holding stick in a first position, in accordance with embodiments of the present disclosure.

FIG. 5 is a second side view of the handheld protective eyewear with the holding stick in a first position in accordance with embodiments of the present disclosure.

FIG. 6 is a top view of the handheld protective eyewear with the holding stick in a first position, in accordance with embodiments of the present disclosure.

FIG. 7 is a bottom view of the handheld protective eyewear with the holding stick in a first position, in accordance with embodiments of the present disclosure.

FIG. 8 is an exploded view of the handheld protective eyewear, in accordance with embodiments of the present disclosure.

FIG. 9 is a view of the handheld protective eyewear with the holding stick in a second position, in accordance with embodiments of the present disclosure.

### DETAILED DESCRIPTION

Embodiments discussed herein provide a handheld protective eyewear usable to protect a user's eyes during spraying substances onto the user's face. Conventional protective eyewear is designed to be secured to a user's head for extended periods of time to enable the user to perform tasks such as carpentry, welding, woodworking, masonry, and so on in a manner that is safe to the user's eyes. Such conventional protective eyewear includes an elastic band or a temple to secure the eyewear in place on a user's head. Such conventional eyewear, though useful for protecting a user's eyes during some types of activities (e.g., construction or demolition activities), are not ideal for protecting a user's eyes during other types of activities. In particular such conventional protective eyewear is inconvenient for protecting a user's eyes during beauty-related activities, such as spraying skincare products (e.g., facial mists, sunscreen, moisturizer, self-tanning spray, etc.) on the user's face. Such conventional protective eyewear can be uncomfortable, mess up a user's hair, be a hassle to repeatedly put on and take off, and cover a part of the face that the user might wish to be exposed to the sprayed skincare products, thus leaving a portion of the user's face uncoated by a facial spray. In contrast, the handheld protective eyewear described in embodiments can be momentarily positioned in front of the user's eyes to protect the user's eyes during spraying of a facial spray on the user's face, and then quickly moved away from the user's face for subsequent beauty routine operations. The handheld protective eyewear described in embodiments does not block the user's face (other than the eyes) from exposure to a sprayed skincare product or other facial spray.

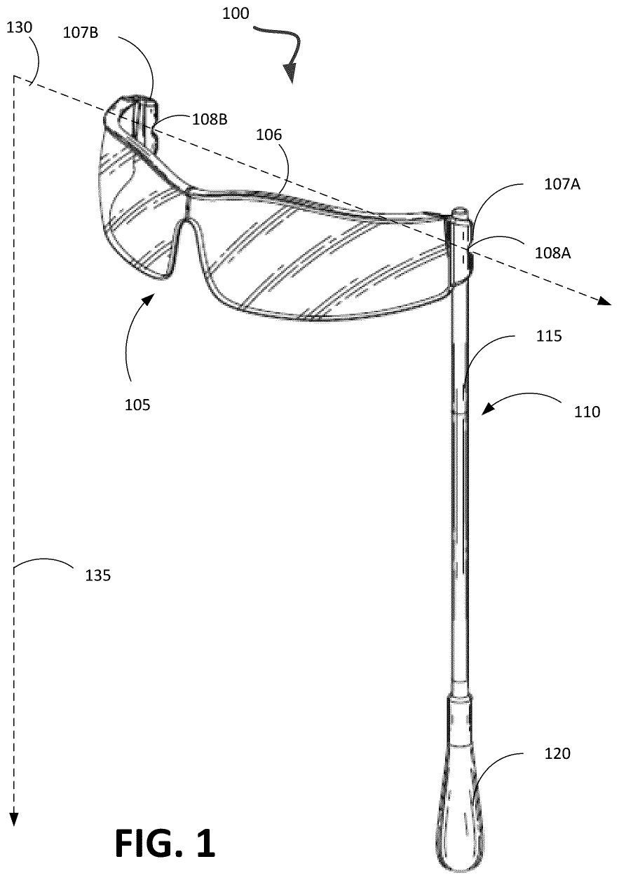

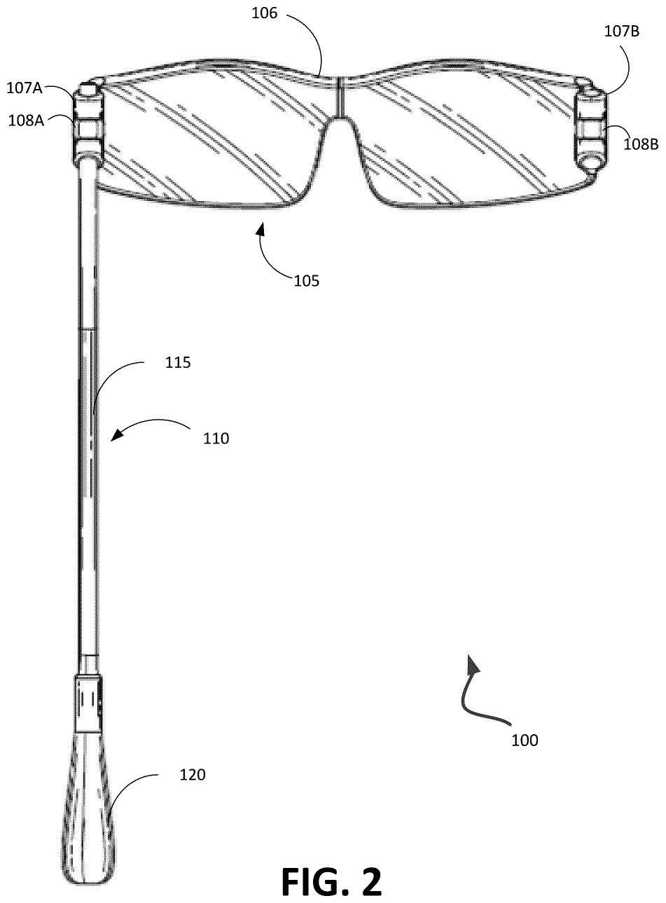

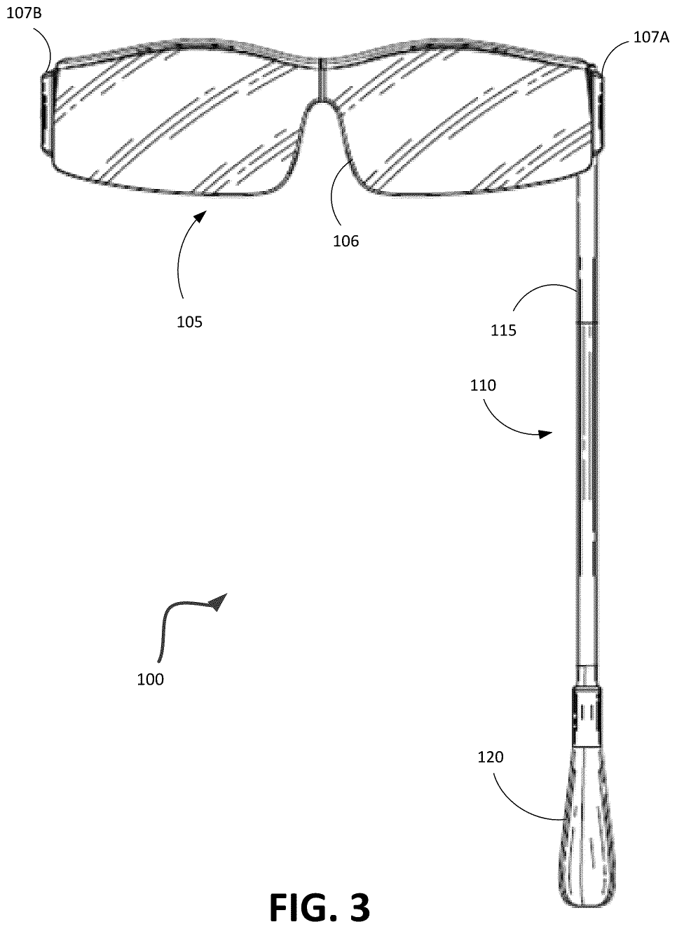

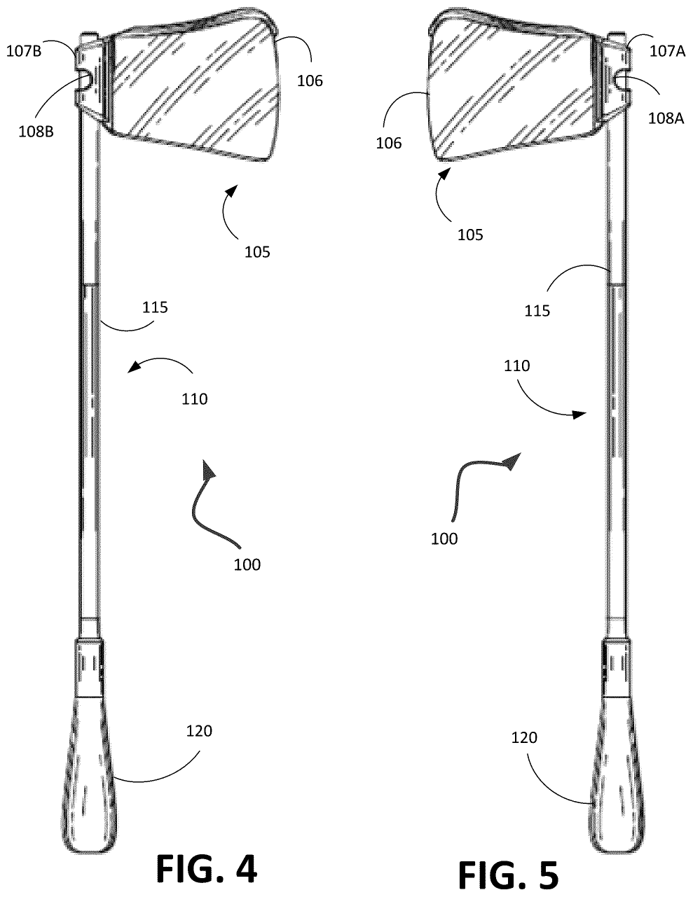

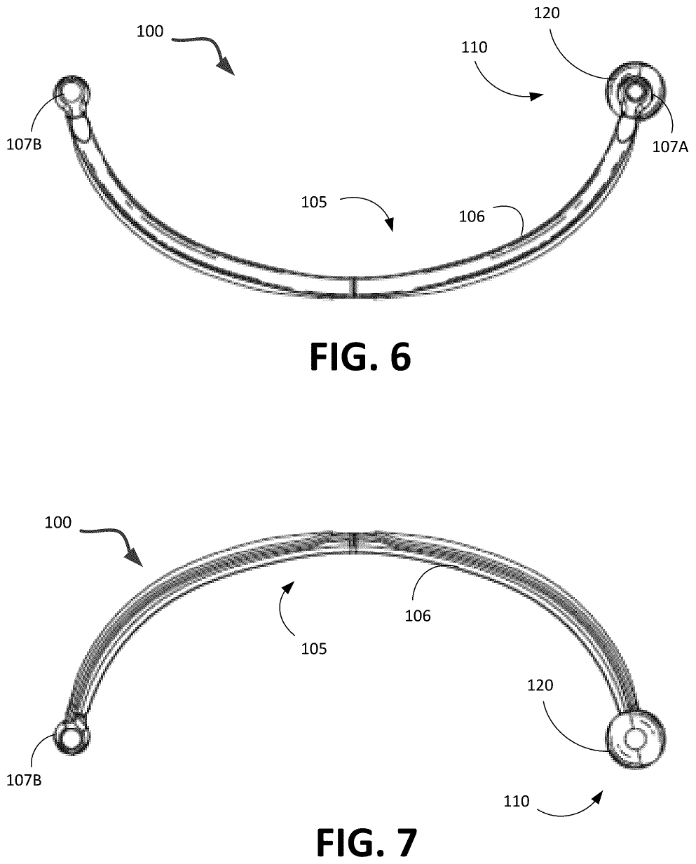

FIGS. 1-7 are views of a handheld protective eyewear 100 with a holding stick 110 in a first position. FIG. 1 is a perspective view of a handheld protective eyewear 100 with a holding stick 110 in the first position, in accordance with embodiments of the present disclosure. FIG. 2 is a front view of the handheld protective eyewear 100 with the holding stick 110 in the first position, in accordance with embodiments of the present disclosure. FIG. 3 is a rear view of the handheld protective eyewear 100 with the holding stick 110 in the first position, in accordance with embodiments of the present disclosure. FIG. 4 is a first side view of the handheld protective eyewear 100 with the holding stick 110 in the first position, in accordance with embodiments of the present disclosure. FIG. 5 is a second side view of the handheld protective eyewear 100 with the holding stick 110 in the first position in accordance with embodiments of the present disclosure. FIG. 6 is a top view of the handheld protective eyewear 100 with the holding stick 110 in the first position, in accordance with embodiments of the present disclosure. FIG. 7 is a bottom view of the handheld protective eyewear 100 with the holding stick 110 in the first position, in accordance with embodiments of the present disclosure.

With reference to FIGS. 1-7, the handheld protective eyewear 100 includes two pieces in embodiments, including an eyepiece 105 and a holding stick 110. The eyepiece 105 includes a lens 106 shaped to cover the left and right eyes of a user and a bridge separating a left side from a right side of the lens 106. The bridge may be shaped to fit over a user's nose when the handheld protective eyewear 100 is placed on or in front of a user's face.

The eyepiece 105 further includes a first holding stick receptacle 107A on a first side of the lens 106 and a second holding stick receptacle 107B on a second side of the lens. The first holding stick receptacle 107A comprises a first hole configured to receive the holding stick 110 oriented in a first direction 135. Similarly, the second holding stick receptacle 107B comprises a second hole configured to receive the holding stick 110 oriented in the first direction 135. As shown, the first direction is orthogonal to a longitudinal axis 130 of the eyepiece 105. The longitudinal axis 110 of the eyepiece 105 extends from the left side to the right side of the eyepiece 105 in embodiments, and is orthogonal to an axis of symmetry of the eyepiece 105 in embodiments. As shown, in embodiments the first hole of the first holding stick receptacle 107A and the second hole of the second holding stick receptacle 107B are orthogonal to the longitudinal axis 130 so as to cause the holding stick to extend in a direction orthogonal to the longitudinal axis 130 (and optionally orthogonal to a viewing axis of a user's eyes wearing the eyepiece 105) when inserted into the first or second hole. In the illustrated example, a first end of the holding stick 110 is inserted into the first hole of the first holding stick receptacle 107A. A user may then hold a second end of the holding stick 110 to position the eyepiece 105 in front of the user's eyes during a spraying procedure.

When the holding stick 110 is inserted into the first hole of the first holding stick receptacle 107A, the protective eyewear 100 is to be held by the user's left hand. When the holding stick 110 is inserted into the second hole of the second holding stick receptacle 107B, the protective eyewear 100 is to be held by the user's left hand.

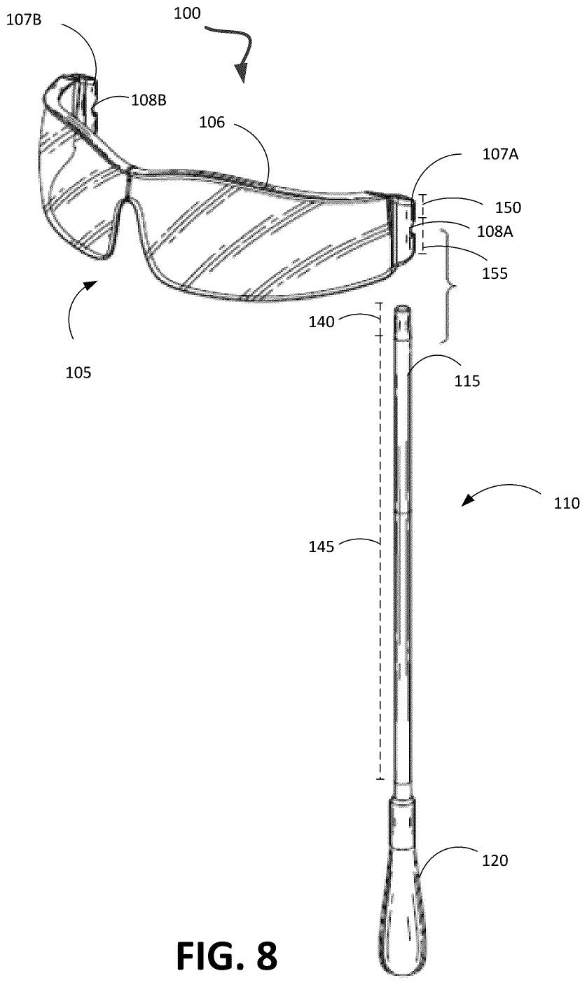

FIG. 8 is an exploded view of the handheld protective eyewear 100, in accordance with embodiments of the present disclosure. The exploded view shows the holding stick 110 removed from the first holding stick receptacle 107A. The holding stick 110 may be removed from the first holding stick receptacle 107A in embodiments by pulling the holding stick 110 away from the eyepiece 105 along an axis that aligns with the hole of the first holding stick receptacle 107A. The holding stick 110 may then be inserted into the second holding stick receptacle 107A or may be otherwise attached to divots/cutouts 108A, 108B in the first and second holding stick receptacles 107A, 107B as described in greater detail below.

The holding stick 110 may have a rod or cylinder shape in embodiments. A first end of the holding stick 110 that inserts into the first or second holding stick receptacle 107A, 107B may have a first diameter that may match or approximately match a diameter of the first hole of the first holding stick receptacle 107A and the second hole of the second holding stick receptacle 107B. In one embodiment, the holding stick 110 may include a first region 140 at the first end having a first diameter and a second region 145 that borders the first region 140 and that has a second diameter that is larger than the first diameter. In one embodiment, the first and second holding stick receptacles 170A, 107B include a hole having a stepped internal diameter. A first section 150 of the first holding stick receptacle 107A may have a first inner diameter that matches or approximately matches a first outer diameter of first region 140 of the holding stick 110, and a second section 155 of the first holding stick receptacle 107A may have a second inner diameter that matches or approximately matches a second outer diameter of second region 145 of the holding stick 110. This enables the holding stick 110 to be inserted into the first and second holding stick receptacles 107A, 107B to a target depth. In one embodiment, the inner diameters of the first and second sections 150, 155 may be the same. In such embodiments, the first region 140 of the holding stick 110 may have a length sufficient to extend into and/or through both the first and second sections 150, 155. This enables the holding stick 110 to be inserted into the first and second holding stick receptacles 107A, 107B to a target depth. In one embodiment, the first and second sections 150, 155 have a same diameter but are separated by a bump or other feature having a slightly larger diameter to ensure that the holding stick 110 inserts into the holes of the first and second holding stick receptacles 107A, 107B to a target depth.

In embodiments, a second end of the holding stick 120 that is opposite the first end includes a handle 120. The handle may be shaped to facilitate ease of holding by a user. In embodiments, the second end of the holding stick 110 (e.g., the handle 120) has a greater diameter than the first end of the holding stick.

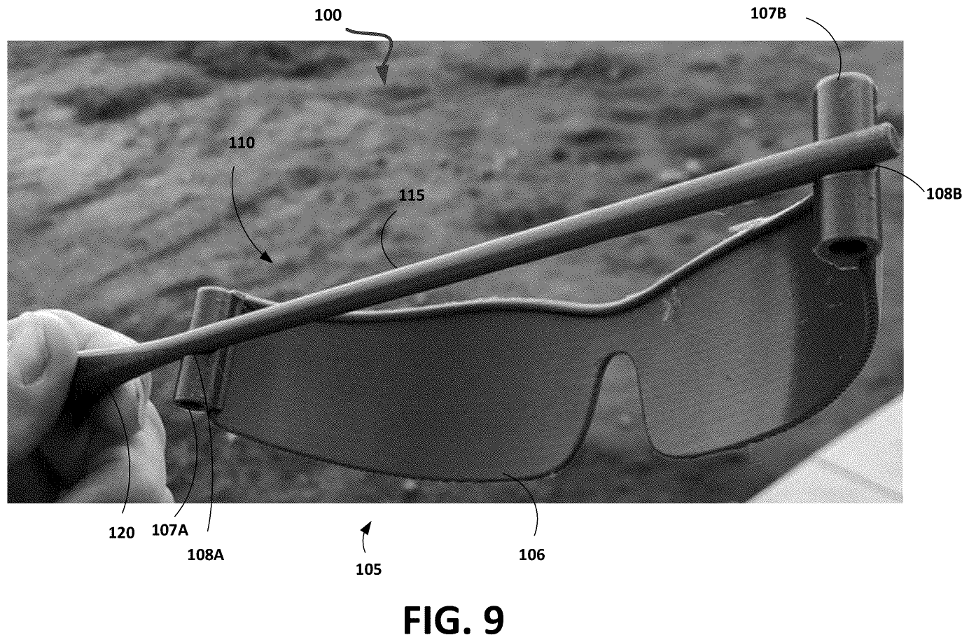

FIG. 9 is a view of the handheld protective eyewear 100 with the holding stick 110 in a second position, in accordance with embodiments of the present disclosure. The second position shown in FIG. 9 may be a storage position that may be used when the handheld protective eyewear 100 is not in use (e.g., when the handheld protective eyewear 100 is to be stored). The handheld protective eyewear 100 may be considered to have a first configuration (e.g., a ready-to-use configuration) when the holding stick 110 is in the first position and to have a second configuration (e.g., a storage configuration) when the holding stick 110 is in the second position. While the handheld protective eyewear 100 has the second configuration it may take up less space and be easier to store.

With reference to FIGS. 1-9, the first holding stick receptacle 107A includes a first divot 108A and second holding stick receptacle 107B includes a second divot 108B. The first divot 108A and second divot 108B may each be approximately half-pipe shaped or C-shaped, and may have an inner diameter that matches or approximately matches an outer diameter of the first and/or second regions 140, 145 of the holding stick 110. The approximately half-pipe or C-shaped divots may be cutouts in the holding stick receptacles 107A, 107B that are orthogonal to the longitudinal axis of the eyepiece 105. In embodiments, the holding stick 110 may snap into place on both of the divots 108A, 108B to attach the holding stick 110 to the eyepiece 105 in the second position such that the holding stick 110 spans the first holding stick receptacle 107A and the second holding stick receptacle 107B. When the holding stick 110 is pressed against the C-shaped cutouts, it causes them to bend or compress slightly to enable the holding stick to move past a narrow lip of the cutouts and into a larger inner diameter area of the cutouts. While the holding stick 110 is attached to the eyepiece 105 in the second position, the holding stick may be aligned with the longitudinal axis of the eyepiece 105.

In embodiments, the eyepiece 105 including the lens 106, the first holding stick receptacle 107A and the second holding stick receptacle 107B may be a single solid body. In embodiments, the holding stick 110 is a separate single solid body. In embodiments, the eyepiece 105 and/or the holding stick 110 are composed of plastic. In some embodiments, the eyepiece 105 and holding stick 110 are composed of a same plastic. In some embodiments, the eyepiece 105 is composed of a see-through or transparent or semi-transparent material. In embodiments, the eyepiece 105 is formed of polycarbonate or a shatterproof plastic. Different plastics that may be used for the holding stick 110 and/or the eyepiece 105 are polycarbonate, polyethylene, acrylic, acatel, polyimide, phenolic and/or another type of plastic.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc., as used herein, are meant as labels to distinguish among different elements and may not have an ordinal meaning according to their numerical designation.

What is claimed is:

1. A protective eyewear, comprising:
a lens configured to protect a user's eyes when placed in front of the user's eyes;
a first holding stick receptacle on a first side of the lens, the first holding stick receptacle comprising a first hole configured to receive the holding stick oriented in a first direction;
a second holding stick receptacle on a second side of the lens, the second holding stick receptacle comprising a second hole configured to receive the holding stick oriented in the first direction; and
the holding stick, configured to insert into at least one of the first hole of the first holding stick receptacle or the second hole of the second holding stick receptacle, wherein the holding stick is configured to be held by the user such that the lens is placed in front of the user's eyes.

2. The protective eyewear of claim 1, wherein when the holding stick is inserted into the first hole of the first holding stick receptacle, the protective eyewear is to be held by the user's left hand.

3. The protective eyewear of claim 1, wherein when the holding stick is inserted into the second hole of the second holding stick receptacle, the protective eyewear is to be held by the user's right hand.

4. The protective eyewear of claim 1, wherein the first holding stick receptacle comprises a first divot configured to receive the holding stick oriented in a second direction that is orthogonal to the first direction, wherein the second holding stick receptacle comprises a second divot configured to receive the holding stick oriented in the second direction, and wherein the holding stick is to snap into place on the first divot of the first holding stick receptacle and the second divot of the second holding stick receptacle such that the holding stick spans the first holding stick receptacle and the second holding stick receptacle.

5. The protective eyewear of claim 4, wherein the first divot is a cutout having a half-pipe shape or a C-shape and the second divot is a cutout having the half-pipe shape or a C-shape.

6. The protective eyewear of claim 1, wherein the lens, the first holding stick receptacle, and the second holding stick receptacle are composed of plastic.

7. The protective eyewear of claim 1, wherein the plastic is a see-through plastic.

8. The protective eyewear of claim 1, wherein the lens, the first holding stick receptacle, and the second holding stick receptacle comprise a single body.

9. The protective eyewear of claim 1, wherein the holding stick comprises a rod having a first diameter at a first end that is approximately equal to a diameter of the first hole and the second hole and a second diameter at a second end that is greater than the first diameter.

10. The protective eyewear of claim 9, wherein the second end of the holding stick comprises a handle.
